(19) United States
(12) Patent Application Publication
(10) Pub. No.: US 2007/0092008 A1
(43) Pub. Date: Apr. 26, 2007

(54) Context-aware frame memory scheme for motion compensation in video decoding

(76) Inventors: Nelson Yen-Chung Chang, Hsinchu City (TW); Tian-Sheuan Chang, Hsinchu City (TW)

Correspondence Address: BUCKNAM AND ARCHER, 1077 NORTHERN BOULEVARD, ROSLYN, NY, 11576, US

(21) Appl. No.: 11/403,588

(22) Filed: Apr. 13, 2006

(30) Foreign Application Priority Data
Oct. 26, 2005 (TW) 94137466

(51) Int. Cl. H04N 11/02; H04N 11/04

(52) U.S. Cl. 375/240.16; 375/240.24

(57) ABSTRACT

The present invention provides a context-aware frame memory scheme for motion compensation in video decoding, which utilizes a motion compensator to receive a data block from input video decoding, follow by processing both inputted context characteristic of residual block and motion vector respectively. The conception of technology is first based on the context characteristic of input video data decoding block, if there is no residual value and motion vector, it will be defined as “perfect match block”; otherwise, “non-perfect match block” instead. Then, the circuit architecture for memory accessing in video decoding provided by present invention will perform different memory access steps for the above mentioned two types of block. If one determines that a block is “non-perfect match block”, selectively choose the reference frame as a back-up data; On contrary, if a block is “perfect match block”, it represents there is no difference between both reference frame and reconstructive frame, hence no access is required to the main frame memory, which means that the access frequency can be minimized; therefore, it can minimize the consumption of the memory capacity as well.

### BACKGROUND OF THE INVENTION

1. Field of the Invention

The present invention relates to a specific frame compensation, which is principally derived from the characteristic of input video decoding data block—Context-aware frame memory scheme for motion compensation in video decoding.

2. Description of the Related Art

With current well-developed network and multimedia technologies, people seem much satisfied with the enjoyment of vision and hearing. However, the meanwhile video image data transport is considerable in spite of the data transport technology has been entered so called “broadband era”. Furthermore, mankind is keep pursuing superior image quality and demanding higher sense enjoyment, a great quantity video image transportation and related image compression technology becomes identical pursuing objective for those correlated industries.

Facing the well-known video decoding system such as MPEG-I [symbol] MPEG-II [symbol] MPEG-IV or H.261 etc., the video image compression technology mostly utilized inter-frame compression technology to minimize mutual frame data redundancies, and results in better date compression.

For example as the FIG. 1 shown, which is one kind of MPEG-IV video compression technologies, relates to the partition video image into required shape decoding [symbol] motion decoding and texture decoding, and they all based on the concept of information entropy to fit the partition scheme principle individually. To achieve the purpose of data compression and eliminate the mutual frame data redundancies in timing axle caused by similarity (such as color, geometric characteristics value, etc.), above mentioned video compression technology is usually adopt motion compensation mode.

What one called motion compensation is actually means one block frame, which is based on the motion vector from motion decoding to generate reference frames, and also collect the corresponding predicted blocks, follow by the predicted block combine with the residual block which is from image lines decoding to obtain the reconstructed frames for the reference of the next frame. In the FIG. 1 indicates the memory which store reference frames and reconstructed frames is called “frame memory”.

According to the above mentioned MPEG-IV image compression technology; there is a ping pong frame register system in current technology market as shown in FIG. 2a, which divides the original main frame memory between a reconstructed frame memory(frame memory 0, FIG. 2a) and a reference frame memory (frame memory 1, FIG.2a), and the ping pong frame image compression method is as follows: (1) First, predict block memory address from motion vector calculation; (2) Then, read a predicted block, and combine with the residual block to obtain the reconstructed frames; (3) Then, write reconstructed block into frame memory to build a reconstructed frame; (4) Last, according to priority, serially read out current frames until the final block completed, exchange reference frame memory and reconstructed frame memory, as shown in FIG. 2b.

The reason to exchange above mentioned two memory is because of the image decoding is based on the previous (t−1) frame as a reference frame to predicts and reconstructs current frame (t). That is why In reply to: the decoding procedure, when t=n, the (reconstructed) frame t=n−1 will be adopted as a reference frame, to predict t=n frame and reconstructed. Assume present (t=n−1) reference frame is stores in the frame memory 0, (t=n) reconstructed frame is write into frame memory 1, and the next (t=n+1) frame requires t=n reconstructed frame as a reference to predicts and reconstructs (t=n+1) frame; however, the present t=n frame is stores in frame memory 1, therefore the frame memory 1 has reference frame inside, as a result of the t=n−1 is useless to reconstructed t=n+1, consequently the t=n+1 reconstructed frame will be write into the original t=n−1 frame memory, which is frame memory 0. Therefore, the frame memory 0 will be name as reconstructed memory.

However, previous mentioned ping pong frame register system requires many reference frames for the displacement compensator purpose, thus these multiple reference frames will occupy much data capacity and drawback to the memory capacity of MPEG-IV decoder increasing. Therefore, facing this problem, there are some preceding patents and technical literature provided the improved methods, such as U.S. Pat. No. 5,978,509; also F. Catthoor and L. Nachtergaele, etc. mentioned an in-place storage optimization circuit frame, refers to “Low power storage exploration for H.263 video decoder” and “Low-power data transfer and storage exploration for H.263 video decoder system”, wherein the difference compare with the precious mentioned ping pong frame circuit is: divides the original main frame memory between a frame memory and a stripe buffer, as shown in FIG. 3a. Next, in the reconstructed frame memory writing step, the block data will be decoded by adopted LIF0 (Last-In-First-Out Buffer, LIFO) access method, the access mode is illustrated as the FIG. 3b shown, which includes:

Step 310: read the predicted block of current block (x,y) from frame memory;

Step 320: predicted block combine with the residual block to obtain the reconstructed block;

Step 330: pop out previous reconstructed block (x−1,y−1) from stripe buffer;

Step 340: make the “pop out reconstructed block” write into the previous reconstructed block position (x−1,y−1) of frame memory;

Step 350: push the reconstructed block (x,y) into the stripe buffer, serially read out current frames until the final block completed.

However, the U.S. Pat. No. 5,978,509 and the technical literature from L. Nachtergaele, etc. provides the in-place storage optimization technology, which temporary solves well-known ping pong frame memory capacity demand, but because utilizing the push/pop technical concept to make the number of access memory too frequently, and caused much power lost from the entire power consumption point of view.

For this reason, facing the image compression technology apply to video decoding motion compensation procedure problem, how to minimize required frame memory capacity and to minimize frame memory access frequency, should becomes a critical research core in this industry.

### SUMMARY OF THE INVENTION

The main objective of present invention is to provide a context-aware frame memory scheme for motion compensation in video decoding system, which combines reference frame memory scheme with reconstructed frame memory scheme, based on the block decoding characteristic of input video context frame. This input video context frame were divided by two different block modes, to process different memory access procedure on both inputted blocks individually, consequently minimizing memory access frequency and minimize memory capacity from the video frame block decoding process.

Another objective of this invention is to provide a circuit architecture of the video decoding memory, based on this architecture to bring up an update procedure for dirty module, to enable two block modes to have different memory access steps respectively, consequently minimizing frame memory access frequency and effectively minimizing memory capacity from video frame block decoding process.

According to the above mentioned objectives of present invention, the context-aware frame memory scheme for motion compensation in video decoding system, which stores reference frame into a search range stripe buffer with a main frame memory scheme. The context-aware frame memory scheme dynamically adjusts memory access steps based on the decoded motion vector to acquire the corresponding predicted block. In present invention frame compensation includes the following steps: (a) utilizing a motion compensator to receive a motion vector and a residual block of a video frame decoding block; (b) according to the numerical comparison of residual block and motion vector, divide them into 1^{st} block mode and 2^{nd} block mode, meanwhile within the residual block, if all pixels equal to “0” and the motion vector also equals to “0”, it represents the 1^{st} block mode (also named as “perfect match block”); on the other hand, if residual block equals “not 0” or motion vector equals “not 0”, it represents the 2^{nd} block mode (also named as “non-perfect match block”); (c) according to the step (b) block mode, if it is 2^{nd} mode, provide a dirty table to determine whether one should access its reference frame from main frame memory scheme or from search range stripe buffer; in contrast, if it is 1st mode, then execute the update steps.

According to the above mentioned objectives of present invention, this memory circuit architecture which combines reference frame with reconstructed frame memory scheme, utilizes the context characteristic of the decoded motion vector received by motion compensator during video decoding to perform different memory access procedures. The memory circuit architecture of present invention includes: one main frame memory [symbol] one search range stripe buffer and one dirty module. Main frame memory is electrically connected to its motion compensator, used for reference frames and reconstructed frames. Search range stripe buffer is electrically connected to its motion compensator, used for store up reference frames, and the dirty module is electrically connected to its motion compensator, used for data record and update the status of every blocks in search range stripe buffer.

### BRIEF DESCRIPTION OF THE DRAWINGS

FIG. 1 shows a MPEG-IV circuit system scheme.

FIG. 2a˜2b shows a circuit scheme of a ping pong frame memory system.

FIG. 3a˜3b expresses the in-place storage optimization circuit scheme.

FIG. 4a is a context-aware frame memory scheme of present invention in video decoding.

FIG. 4b is a memory scheme chart of present invention.

FIG. 5 is a flow chart of a context-aware frame memory scheme for motion compensation in video decoding in present invention.

FIG. 6a is a flow chat of residual block generation.

FIG. 6b˜6d shows a series flow charts of the “non-perfect match block” generation in present invention.

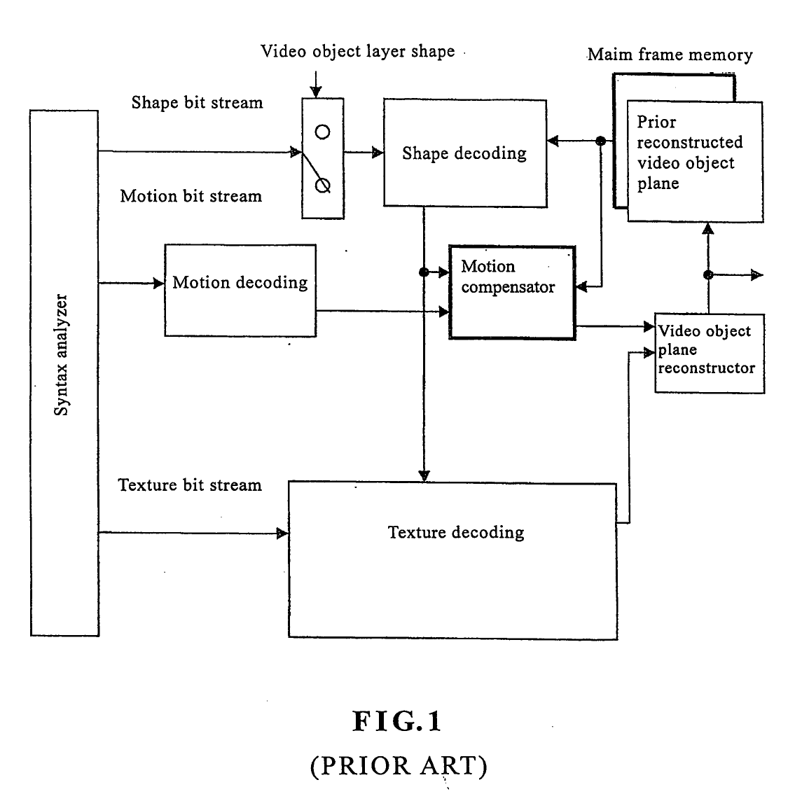

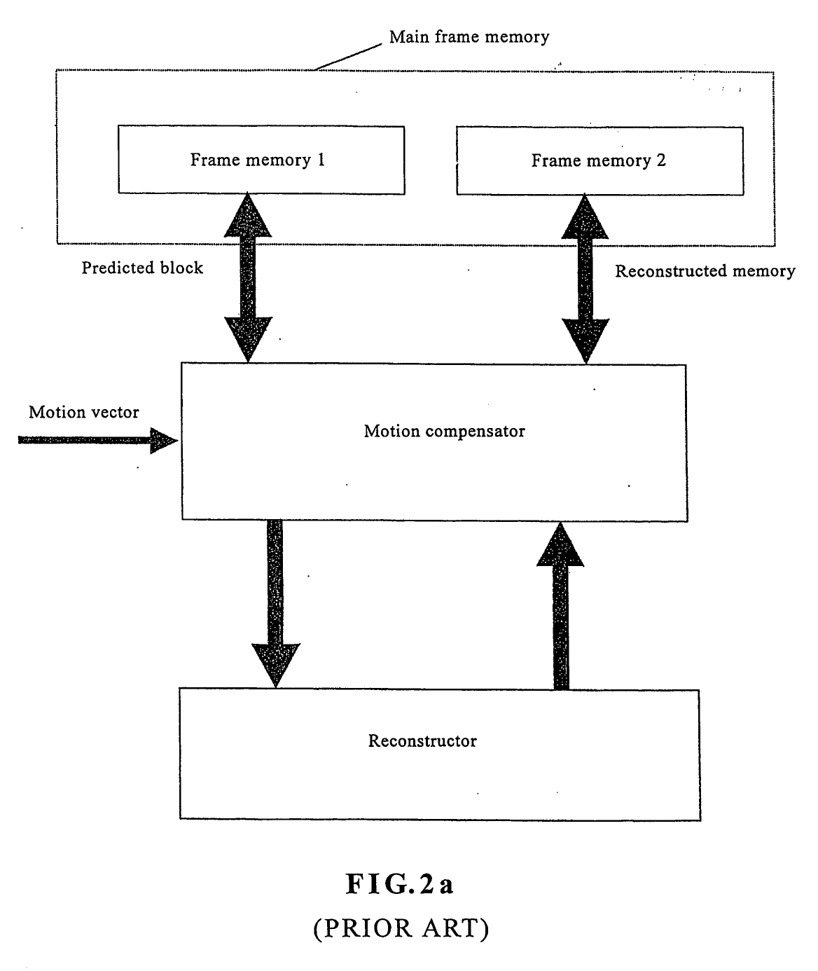

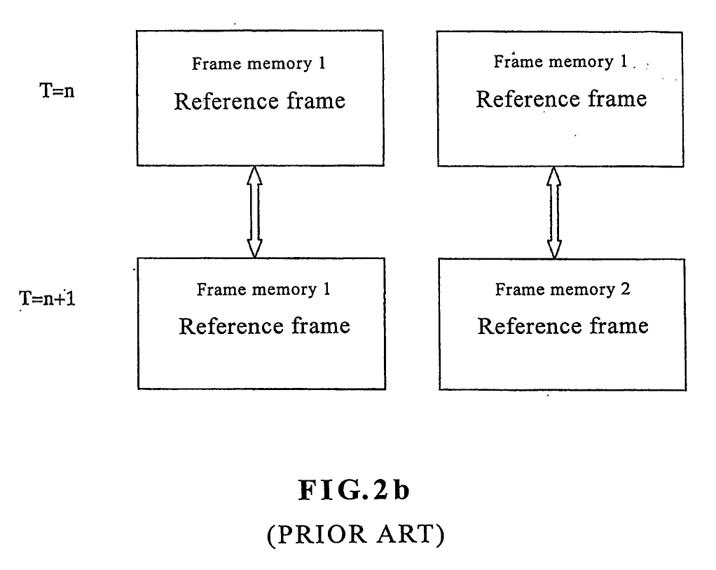

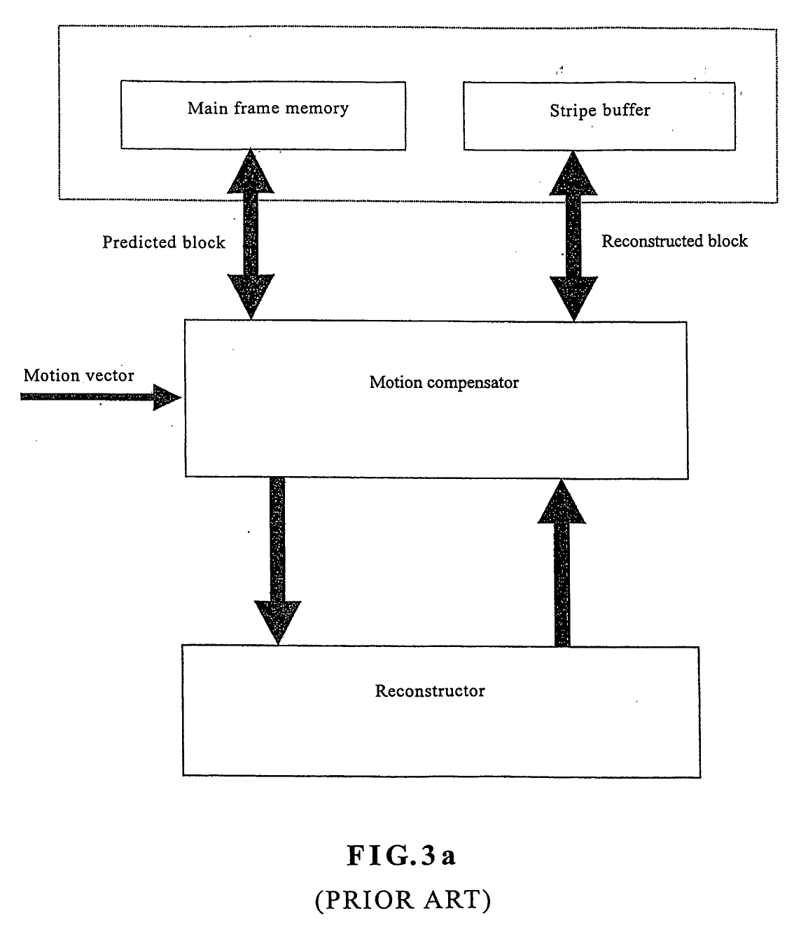

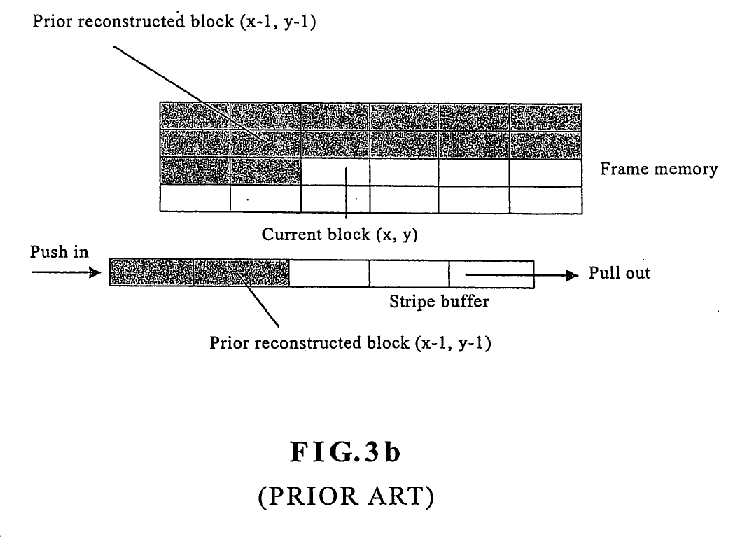

### DETAILED DESCRIPTION OF THE PREFERRED EMBODIMENTS

The following content described a present better execution example in more details. However, what should be understood is, this invention offers a lot of applicable invention ideas, which can be reflected in a very broad, various, and specific and concrete background. The discussed specific embodiment of the present invention is illustrative only, and it is not used to limit the scope of the invention.

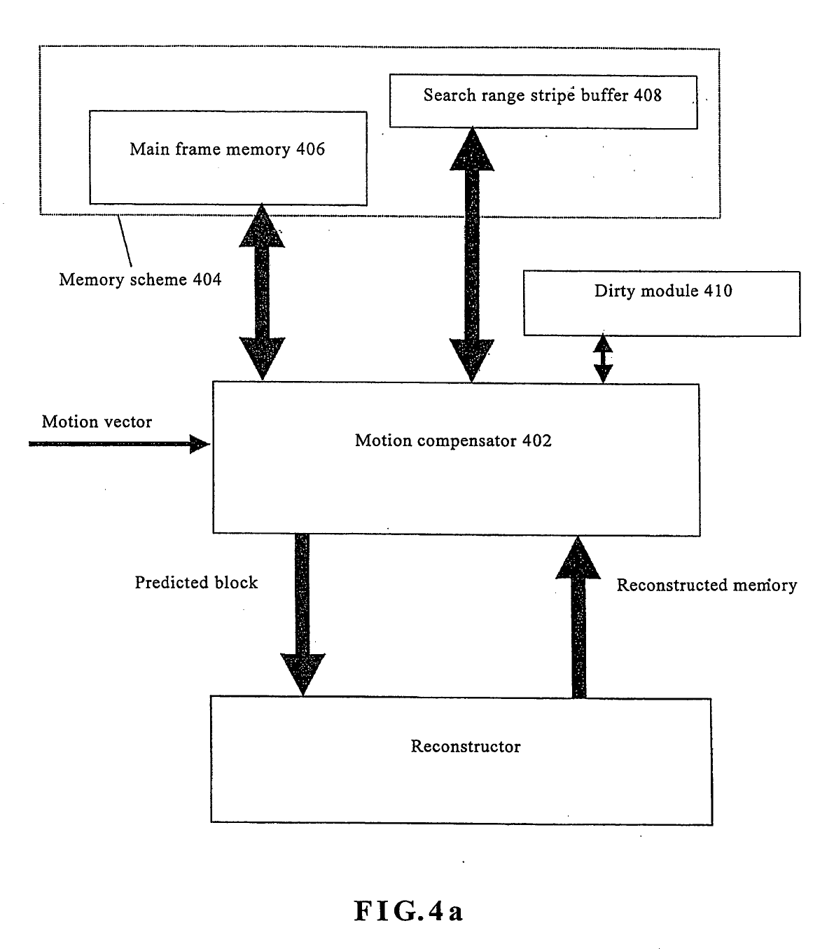

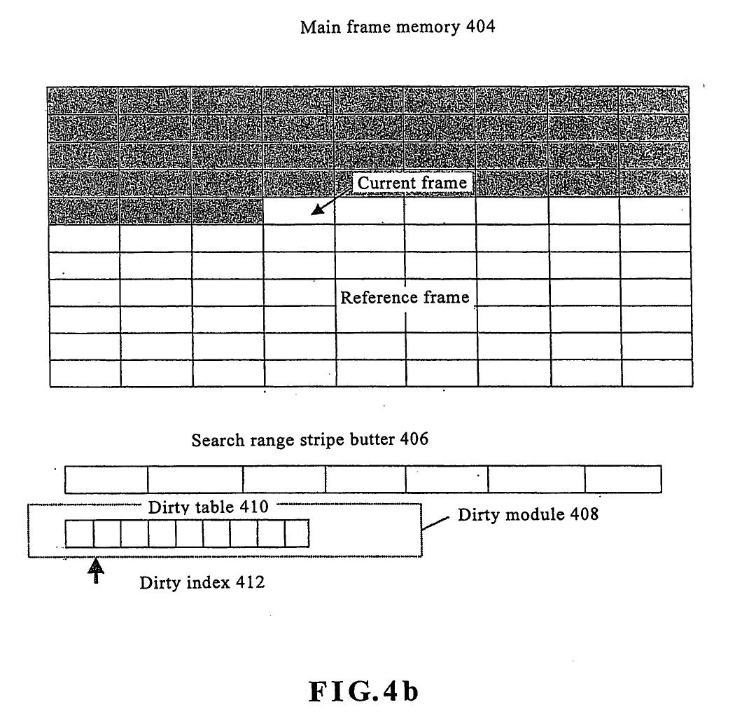

Please refer to the FIG. 4a, explains present invented circuit architecture of video decoding system, which decodes an encoded and compressed digitized video data, in order to generate a decoded video frame; wherein the encoded and compressed data were referred as “bitstream”. The circuit of this decoding system includes: a motion compensator 402, is used to receive a decoded bitstream block; a memory scheme 404 is electrically connected to its motion compensator, which includes a main frame memory 406, is used to store reference frame and reconstructed frame; a search range stripe buffer (SRSB) 408, is used to store reference frame; a dirty module 410, which contains a dirty table 412 and a dirty index 414 as shown in FIG. 4b, wherein the dirty table 412 keeps the update status of each entry in search range stripe buffer 408, and the dirty index 414 is a moving indication label, which represents the current processing decoding block.

The present invention of the video decoding operation dynamically adjusts memory access steps based on the decoded motion vector received from motion decoding to get the corresponding predicted block from reference frame. By this way, this invention effectively minimize memory access frequency and minimize memory capacity from the video frame block decoding process.

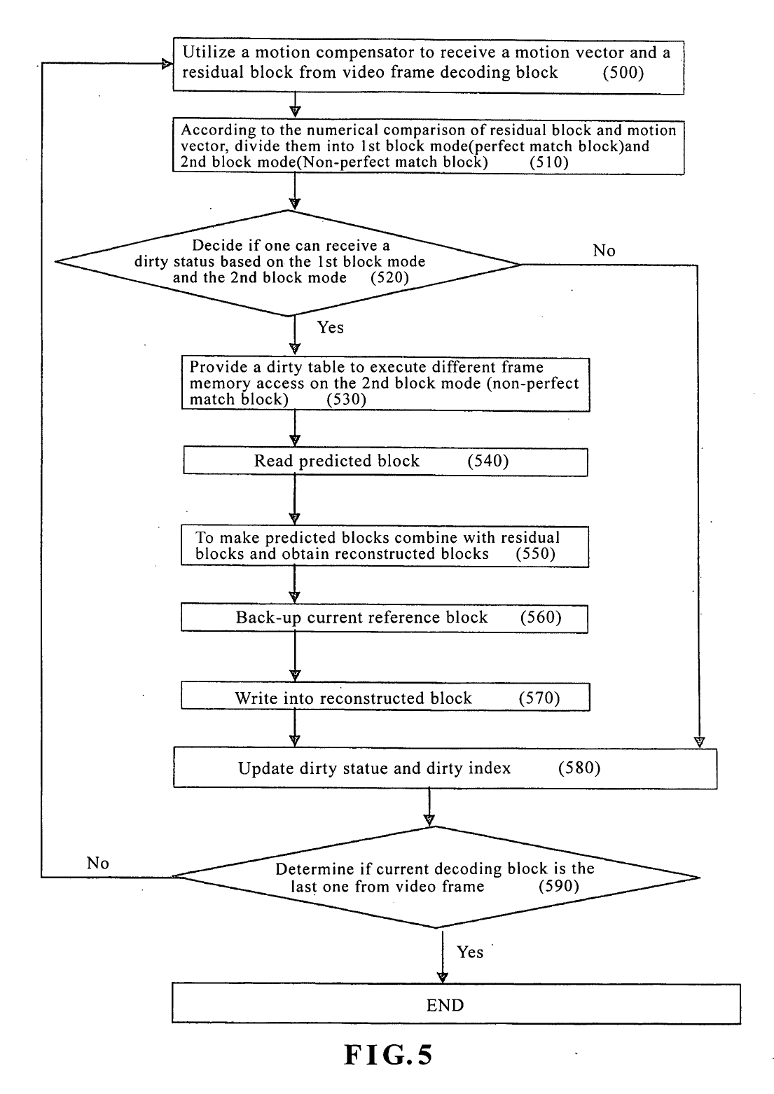

Please refer to the FIG. 5, a flow chart of a context-aware frame memory scheme for motion compensation in video decoding of the present invention is depicted. The following statement will explain the detailed operation of present invention.

Step 500, utilizing a motion compensator to receive a motion vector and a residual block from the current video frame decoding block.

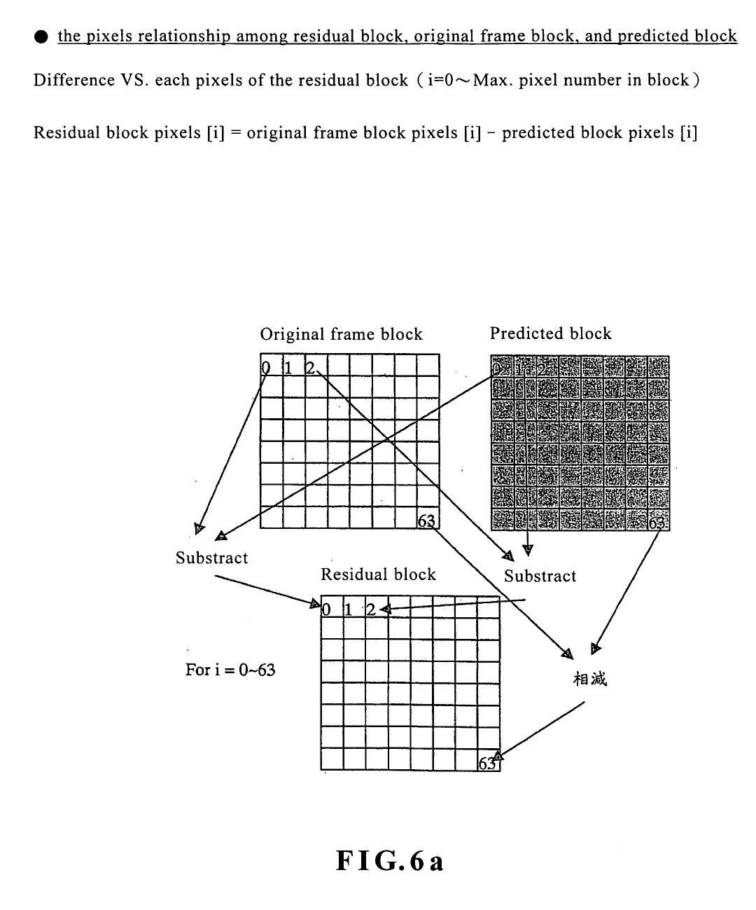

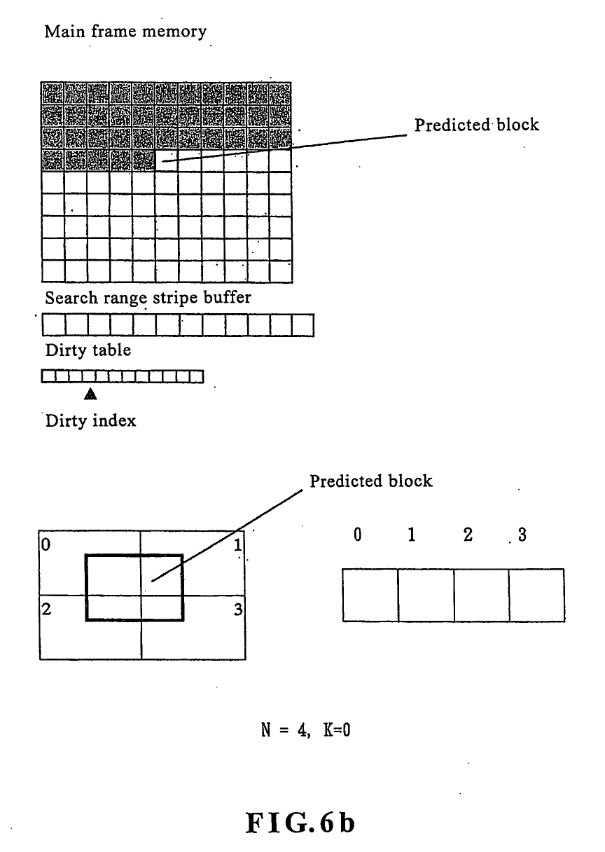

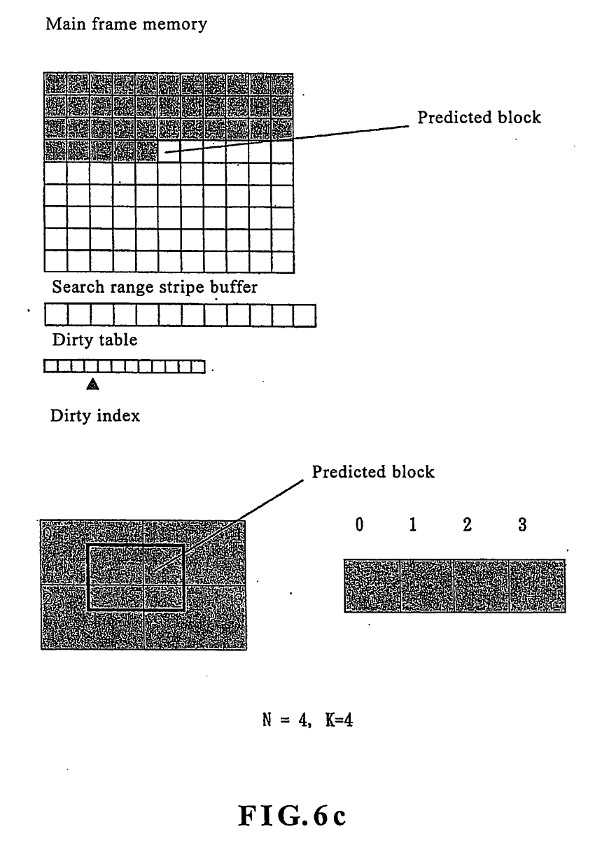

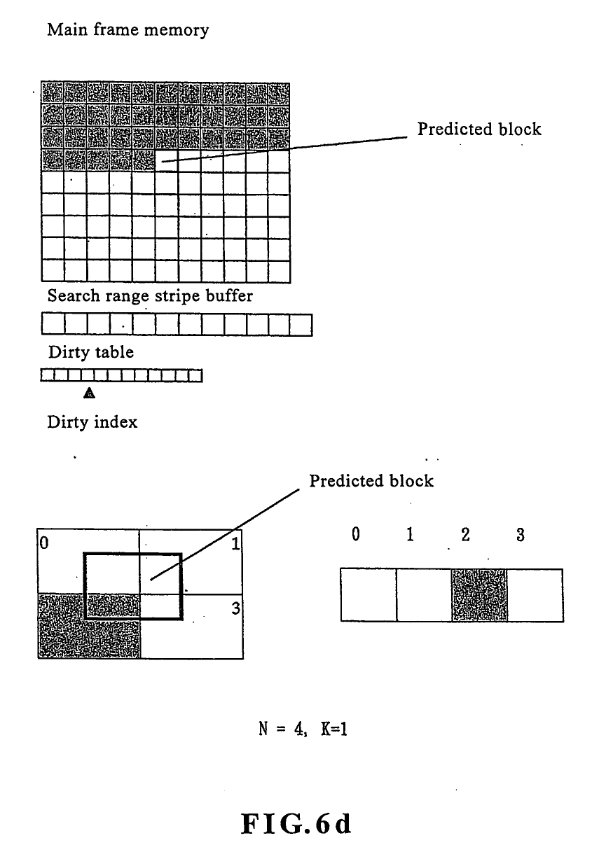

Among which, residual block is the difference between all decoding block pixels (also means brightness) from current input video data and all corresponding predicted block pixels (also means brightness) from reference frame, please refer to the FIG. 6a shown.

Step 510, according to the numerical comparison of residual block and motion vector, divide them into 1^{st} block mode and 2^{nd} block mode, meanwhile within the residual block, if all pixels equal to “0” and the motion vector also equals to “0”, it represents the 1^{st} block mode (also named as “perfect match block”); on the other hand, if residual block equals “not 0” or motion vector equals “not 0”, it represents the 2^{nd} block mode (also named as “non-perfect match block”);

Step 520, determine if one should get dirty status. According to step 510, if the inputted video data decoding block is judged as a perfect match block, execute step 580, to update the corresponding dirty table values of this block (means the dirty status of this block as not-updated), and make the dirty index point to the next dirty table position that correspond to the next decoding block; otherwise, execute step 530 if the decoding block is judged as a non-perfect match block: check inside dirty table and see if it is updated.

Step 530, check if the non-perfect match block is updated or not. In the searching process, the dirty status within the dirty table will inform motion compensator to read the predicted block either from main frame memory or from search range stripe buffer, or from both of the above mentioned main frame memory and search range stripe buffer together. Wherein the dirty table will inform motion compensator based on the following conditions:

If the predicted block contains plural number (such as “N”) of reference blocks' (reference frame block, abbreviated as “reference block” below) partial pixels, the dirty status that correspond to plural (such as “N”) reference blocks needs to be checked, in order to offer the non-perfect match block indications to which memory is to be read.

There are two different values in the above mentioned dirty status: updated and not-updated, updated represents the corresponding reference block has been stored in the search range stripe buffer; on the other hand, non-updated represents the corresponding reference block has been stored in the main frame memory.

Please refer to the FIG. 6b, if all plural number (such as “N”) of reference blocks that correspond to dirty status informs these plural number (such as “N”) of reference block pixels were stored in main frame, then the motion compensator should only read the data from main frame memory, explain as follows:

Once a predicted block contains 4 (0˜3,N=4) reference blocks, “K” indicates the status of updated block, K≦4; K=0 means none of the reference blocks been updated, thus it also represents all block pixels were store in the main frame memory; consequently, one (the motion compensator) should only read the predicted blocks from the main frame memory.

Please refer to the FIG. 6c, on the other hand, if the dirty status informs these 4 reference block pixels as updated, at K=4, This represents all block pixels information were store in the search range stripe buffer; consequently, one (the motion compensator) should only read the predicted blocks from the search range stripe buffer.

Please refer to the FIG. 6d, if the dirty status from dirty table indicates 4 reference blocks only with partial pixels update, as this figure shown; once the reference block-2 been updated from 4 reference blocks, the data of reference block-2 will be stored in the search range stripe buffer, and the other 3 reference blocks (reference block-0 [symbol] reference block-1 [symbol] reference block-3) with all pixels will be stored in the main frame memory, hence the motion compensator can read the predicted block from both main frame memory and search range stripe buffer together.

Step 540, read predicted blocks; based on the judgment results of step 530 on reading its predicted block; for the predicted block containing all plural number (such as “N”) reference blocks, if reference blocks' corresponding dirty status is updated, the corresponding reference block pixels within the predicted block will be read from search range stripe buffer; on the contrary, if the dirty status indicates not-updated, the reference block pixels within the predicted block will be read from main frame memory.

Step 550, generate reconstructed blocks; combines predicted block with residual block to obtain reconstructed block.

Step 560, back-up current reference block; due to that the reconstructed block will finally be written into main frame memory, where the writing position is exactly on the position of current processing decoding block; therefore, one must back-up the reference frame at current decoding block position into the search range stripe buffer. Wherein the back-up mode, which reads out current reference frames from the main frame memory, and writes it into the search range stripe buffer at the position pointed by dirty index. Besides, the current pointed position in dirty table will be updated and shows the updated state.

Step 570, write reconstructed block; after step 560 completed, The reconstructed block will be written into current decoding block position in the main frame memory, in order to establish reconstructed frame.

Step 580, execute updating steps; update dirty status that corresponds to decoding block, followed by updating dirty index.

If the current decoding block is a perfect match block, the dirty status value in dirty table. is not updated; on the contrary, it is updated. Followed by the dirty index update, which points the index to the next corresponding dirty table position of the next expected decoding block.

Step 590, determine if current decoding block is the last one of a video frame. If the motion compensator is not receiving the last decoding block, continue to execute step 500.

To synthesize above mentioned content, the present invention, context-aware frame memory scheme for motion compensation in video decoding contains the most critical technical characteristic, which processes both inputted context characteristic of residual block and motion vector individually.

The conception of technology is first based on the input video data decoding block, if there is no difference (also means brightness) between each pixels and reference frames which corresponds to a predicted block without any residual value and motion vector, it will be defined as “perfect match block”; otherwise, “non-perfect match block” instead.

Then, a circuit frame of the video decoding access memory provided by present invention will be applied to above mentioned two blocks for memory access process individually. If one determines that they are “non-perfect match block”, selectively choose the reference frame as a back-up data; On contrary, if they are “perfect match block”, it represents that there is no difference between both reference frame and reconstructive frame, hence no access is required to the main frame memory, which also means the memory access frequency minimization; therefore, it can also minimize the consumption of the memory energy.

The above preferred embodiment of the present invention is illustrative only; it is not used to limit the scope of the invention. The equivalent changes and modifications not departing from the claims below should still pertain to the scope of the invention.

1. A context-aware frame memory scheme for motion compensation in video decoding, which stores reference frame into a scheme of search range stripe buffer (SRSB) and main frame memory (MFM). The context-aware frame memory scheme dynamically adjusts memory access steps based on the decoded motion vector and the corresponding predicted block mode. In present invention frame compensation includes the following steps:
(a) utilizing a motion compensator to receive a motion vector and a residual block of a video frame decoding block; (b) according to the numerical comparison of residual block and motion vector, divide them into 1^{st} block mode and 2^{nd} block mode, meanwhile within the residual block, if all pixels equal to “0” and the motion vector also equals to “0”, it represents the 1^{st} block mode (also named as “perfect match block”); on the other hand, if residual block equals “not 0” or motion vector equals “not 0”, it represents the 2^{nd} block mode (also named as “non-perfect match block”); (c) according to the step (b) block mode, if it is 2nd mode, provides a dirty table to determine whether one should access its reference frame from main frame scheme or from search range stripe buffer; on contrary, if it is 1^{st} t mode, then execute the update steps, and make dirty index point to the next corresponding dirty table position from decoding block.

2. The context-aware frame memory scheme for motion compensation in video decoding system as claimed in claim 1, where base on the step(c), if the predicted block contains plural number (such as “N”) of reference block with partial pixels, then the plural reference blocks corresponding with dirty status needs to be checked; hence if there are plural number (such as “N”) of corresponding dirty status show plural reference block (such as “N”) pixels were stored in main frame, the motion compensator should only read the predicted blocks from main frame memory.

3. The context-aware frame memory scheme compensation in video decoding system as claimed in claim 1, wherein based on the step(c), when the dirty status informs that this plural number (such as “N”) of reference block pixels were stored in search range stripe buffer, the motion compensator should only read the predicted blocks from search range stripe buffer.

4. The context-aware frame memory scheme compensation in video decoding system as claimed in claim 1, wherein based on the step(c), according to the dirty status acquired from dirty table for plural number (such as “N”) of reference blocks, some (such as “K”, Kᵢ∅N) reference blocks' pixels will be stored in the main frame memory, and number N-K of reference block pixels will be stored in the search range stripe buffer and the motion compensator can read the predicted block from both main frame memory and search range stripe buffer together.

5. The context-aware frame memory scheme compensation in video decoding system as claimed in claim 1, wherein based on the step(c), access its reading predicted blocks, further steps include:
(c1) generating reconstructed block to combine predicted block with residual block to obtain reconstructed blocks;
(c2) backing-up current reference block which back-up the reference frames from current decoding block position into its search range stripe buffer;
(c3) writing reconstructed block in order to establish reconstructed block;
(c4) executing updating steps which utilizes its dirty table to update current dirty status that correspond to decoding block, and utilizing its dirty index of the dirty table point to next (decoding) block.

6. A context-aware frame memory scheme in video decoding, which combines reference frame with reconstructed frame memory scheme, and utilizing a motion compensator to execute different memory circuit access steps by its content characteristic, which is received from the motion vector of video decoding, and the memory circuit frame includes:
one main frame memory (MFM), is electrically connected to its motion compensator, used for storing reference frames and reconstructed frames;
one search range stripe buffer (SRSB), is electrically connected to its motion compensator, used for storing reference frames; and
one dirty module, is electrically connected to its motion compensator, used for keeping record of the update status of every block in search range stripe buffer.

7. The context-aware frame memory scheme in video decoding as claimed in claim 6, wherein the dirty module is constructed by a dirty table and a dirty index.
